(19) United States
(12) Patent Application Publication
(10) Pub. No.: US 2010/0164665 A1
(43) Pub. Date: Jul. 1, 2010

(54) METHOD FOR MANUFACTURING INDUCTIVE ELECTRIC COMPONENT, AND INDUCTIVE ELECTRIC COMPONENT

(75) Inventor: Pertti SEVÄKIVI, Lepsama (FI)

Correspondence Address: BUCHANAN, INGERSOLL & ROONEY PC, POST OFFICE BOX 1404, ALEXANDRIA, VA, 22313-1404, US

(73) Assignee: ABB OY, Helsinki (FI)

(21) Appl. No.: 12/646,215

(22) Filed: Dec. 23, 2009

(30) Foreign Application Priority Data
Dec. 29, 2008 (FI) 20086244

(51) Int. Cl. H01F 27/08; H01F 7/06

(52) U.S. Cl. 336/61; 29/602.1

(57) ABSTRACT

A method and electric component, such as inductor, coil, resistor, or the like, are disclosed wherein a winding includes at least one spiral or coiled element, the spiral or coiled element being formed from a piece furnished with cooling ribs.

### RELATED APPLICATION

This application claims priority under 35 U.S.C. §119 to Finnish Patent Application No. 20086244 filed in Finland on Dec. 29, 2008, the entire content of which is hereby incorporated by reference in its entirety.

### FIELD

The disclosure relates to a method for manufacturing an inductive electric component, such as inductor, coil, resistor, or the like, having at least one spiral or coiled element. The disclosure also relates to an inductive electric component of this type.

### BACKGROUND INFORMATION

An inductive electric component may be an inductor, for instance, that is used in an electric device as a filtering component, for instance. The number of conductor turns, external dimensions, and the core material can affect the inductance of the inductor.

Known spiral or coiled elements are made of filamentous material coiled on the core material. Air-core elements are also coiled on a support structure.

Known coiling can involve substantial manual work and costs during manufacture. In addition, cooling can also be associated with a thick coil, and/or a water cooling arrangement can be used to provide a desired amount of cooling.

### SUMMARY

A method is disclosed for manufacturing an inductive electric component, comprising: furnishing a piece of material having cooling ribs; and water-cutting at least one winding into the piece such that at least one spiral or coil element of the winding contains at least a portion of the cooling ribs.

An electric component is disclosed, comprising: a piece of material furnished with cooling ribs; and a water-cut winding having at least one spiral or coiled element, such that at least one spiral or coil element of the winding contains at least a portion of the cooling ribs.

### BRIEF DESCRIPTION OF THE DRAWINGS

Other objects and advantages will be described with reference to the attached drawings, in which:

FIGS. 1 to 5 show different exemplary embodiments of an electric component furnished with cooling ribs.

### DETAILED DESCRIPTION

An exemplary method and electric component are disclosed wherein a winding (e.g., spiral or coiled element) is formed from a piece furnished with cooling ribs, and wherein the element is formed by water-cutting.

The component can be, for example, an inductor or resistor element water-cut into a “spring” from plate material or a pipe-like profile having a selected thickness. The starting material can be, for example, extruded aluminum profiles, copper rods and pipes, and stainless steels having different wall thicknesses. At least one surface of the plate material can be furnished with cooling ribs, or at least one of inner and outer surfaces of the pipe profile can be furnished with cooling ribs.

Exemplary methods disclosed herein can provide an efficient air-cooling for the element during its manufacture, and water-cutting can provide a dimensionally accurate product in a modern manner involving a minimum amount of manual work. The method can be flexible and easily applicable to different element shapes. The product can be applied to different currents, and it is possible to manufacture even very small coils.

The width of the water-cutting groove is, for example, 1 to 2 mm, or lesser or greater. The narrow cutting groove of an element cut from plate material can, for example, be filled with varnish or resin that binds the piece back into a plate-like element. The cut element can also be supported mechanically.

If desired, the current strength of an inductor, for example, can be increased by connecting several coil spirals in parallel. Correspondingly, the inductance of the inductor can be increased by connecting several coil spirals in series.

Where an exemplary water-cutting approach is used in the method, a wide range of materials can be used, and the method can be used to cut thicker materials than with a laser, for example. Water-cutting does not generate heat in the material being cut, which means that the material does not warp during cuting. In water-cutting, the material being cut is penetrated by concentrating a high energy density to it with a thin water jet at approximately 1000 m/s, more or less. This water jet can be provided with a high-pressure pump that generates a high pressure. Water-cutting can be a very efficient, but also a very gentle method. No material burning or melting, gas or slag formation, cracking, breaking, or chemical changes occur in the material being processed. The outlet side of the water jet can remain flawless. Water-cutting can also be done using multiple (e.g., two) techniques, either with water only, or by using abrasive sand in addition to water. For example, when using abrasive sand, the water jet sweeps along from the ejectors hard sand crystals, with which all hard and strong materials can be cut.

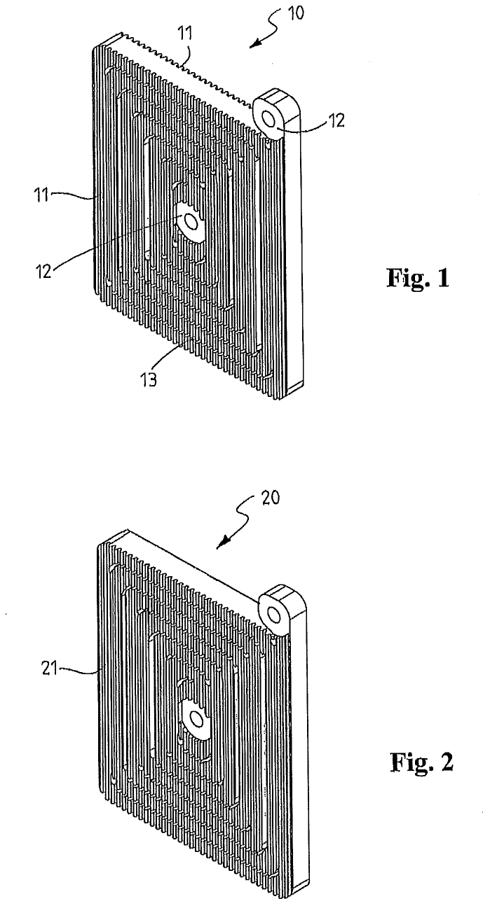

FIG. 1 shows in perspective an exemplary element 10 of the electric component of the disclosure in the shape of a horizontal spiral, the element being formed by water-cutting it from plate material that is furnished with cooling ribs 11 on both sides. This way, the cut element 10 can obtain cooling ribs without any additional work steps. Perforated connecting points 12 for electric connections can be formed, for example, at the forward end in the middle of the element 10 and the tail end on its edge. The ribs can be machined away from the surfaces of these connecting points 12 to ensure a better connection contact. The water-cutting groove is marked with reference number 13.

The exemplary element 20 shown in FIG. 2 corresponds to the element in FIG. 1 except that here the cooling ribs 21 are only on one side of the element 20; that is, it is made of a starting material having ribs on one side only.

FIG. 3 shows in perspective an exemplary coiled element 30 of the electric component of the disclosure which is formed by water-cutting from a pipe-like starting material with both inner and outer surface furnished with cooling ribs 31. At the ends of the element 30, holes 32 are formed for electric connections, and their surfaces are machined smooth as in the exemplary embodiments of FIGS. 1 and 2. A dimensionally accurate constant-width coiled ribbon can be achieved with a constant-size water-cutting groove 33. The pitch of the thread and the width of the element 30 can be easy to implement to a required size. The same applies to the thickness of the element 30.

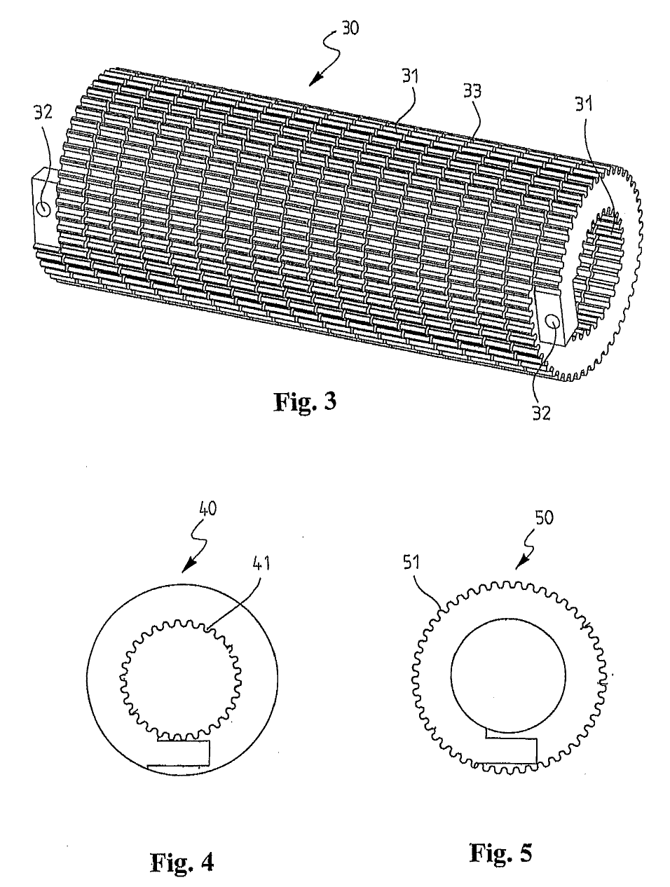

The end view of FIG. 4 shows an exemplary coiled element 40 that corresponds to the electric component 30 of FIG. 3 except that here the cooling ribs 41 are only on the inner surface of the element 40.

The end view shown in FIG. 5 shows in turn an exemplary coiled element 50 that corresponds to the electric component 30 of FIG. 3 except that here the cooling ribs 51 are only on the outer surface of the element 50.

The cutting grooves in each case can, for example, be filled with varnish, resin or other suitable material, to support the element.

The above description of the disclosure is only intended to illustrate the basic idea of the disclosure. Thus, a person skilled in the art may modify its details in any of numerous, readily apparent ways including, but not limited to, combining features from any or all of the exemplary embodiments disclosed herein.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for manufacturing an inductive electric component, comprising:
furnishing a piece of material having cooling ribs; and
water-cutting at least one winding into the piece such that at least one spiral or coil element of the winding contains at least a portion of the cooling ribs.

2. The method as claimed in claim 1, wherein the element is formed from plate material.

3. The method as claimed in claim 1, wherein the element is formed from a pipe profile.

4. The method as claimed claim 1, wherein the element is selected from a group consisting of:
aluminum, copper, and steel.

5. An electric component, comprising:
a piece of material furnished with cooling ribs; and
a water-cut winding having at least one spiral or coiled element, such that at least one spiral or coil element of the winding contains at least a portion of the cooling ribs.

6. The electric component as claimed in claim 5, wherein the element is a piece formed of plate material, with at least one surface of the plate material being furnished with cooling ribs.

7. The electric component as claimed in claim 5, wherein the element is made of a pipe profile, with at least one of inner and outer surfaces of the pipe profile being furnished with a cooling rib.

8. The electric component as claimed in claim 5, wherein the material of the element is selected from a group consisting of: aluminum, copper, and steel.
